(19) United States
(12) Patent Application Publication
(10) Pub. No.: US 2007/0057401 A1
(43) Pub. Date: Mar. 15, 2007

(54) PARTIALLY COVERED TWO-SHOT TRIM PANEL

(75) Inventors: David J. Dooley, Troy, MI (US); Glenn A. Cowelchuk, Chesterfield Township, MI (US); Todd L. DePue, Brighton, MI (US); Randy S. Reed, Fair Haven, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,546

(22) Filed: Sep. 14, 2005

(51) Int. Cl. B29C 45/14; B29C 37/00

(52) U.S. Cl. 264/161; 264/259; 264/255; 428/172

(57) ABSTRACT

A method of making automobile interior panels includes a step in which a first insert is positioned in the cavity formed by a first and second mold section. The first insert is trimmed by a first lifter to form a trimmed first insert. A first resin is subsequently introduced into a second mold cavity such that this first resin bonds to the trimmed first insert. Complex interior panels are formed by utilizing additional lifters and/or mold sections to define mold cavities and paths for introducing additional resins.

### BACKGROUND OF THE INVENTION

1. Field of the Invention

The present invention is related to multi-component automobile interior panels made by injection molding.

2. Background Art

Multishot molding is a type of injection molding process in which a plastic part having several different colors or several different resins is formed. For example, in two shot molding a plastic part is formed from two different materials. This process is easily automated and able to produce success parts such as buttons and gear wheels with a firm core yet a soft feel. Although multi-material molding is a relatively new molding technology in the United States, it has been popular in Europe for a number of years. Multishot molding is particularly useful for hard and soft combinations of resins, multicolored components, housing or connectors with seals or gaskets, grips and tactile applications, back-lit graphics, weatherproofing, and vibration reduction. Accordingly, multishot molding is potentially useful for fabrication of automobile interior components.

In the typical two shot method, a first resin is injected into the molding apparatus to form a pre-molded part. Next, a second unit injects a second resin onto the premolded part. Typically, the two shot process is automated to form articles having different combinations of resins or colors. Although the two shot process works well, fabrication of multicomponent parts such as automobile trim panels often include a number of discrete steps that add to the overall cost of a part.

Accordingly, there is a need for multishot molding processes in which fabrication steps are reduced or combined together.

### SUMMARY OF THE INVENTION

The present invention overcomes one or more problems of the prior art by providing in at least one embodiment a method of making automobile interior panels. The method of this embodiment comprises positioning a first insert in a first mold cavity. The first mold cavity is formed by the appropriate relative positioning of a first mold section and a second mold section. Advantageously, the first insert is trimmed by a first lifter to form a trimmed first insert. The first mold section, the second mold section, the first lifter, and the trimmed first insert are positioned to form a second mold cavity. A first resin is then introduced into the second mold cavity such that this first resin bonds to the trimmed first insert. In variations of this embodiment, additional lifters and/or mold sections are used to define mold cavities and paths for introducing additional resins to form more complex interior panels.

In another embodiment of the present invention, an automobile interior panel made by the methods set forth above for the first embodiment is provided. The automobile panel of this embodiment is characterized in that at least one applique is attached to a substrate with an over-molded bond.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is an idealized side view of an automobile interior panel made by the method of the invention;

FIG. 2 is an idealized side view of an automobile interior panel made by the method of the invention;

FIG. 3A is a flowchart illustrating a method of forming an automobile interior panel in accordance with an embodiment of the present invention; and

FIG. 3B is a continuation of FIG. 3A.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENT(S)

The following description of the preferred embodiments is merely exemplary in nature and is in no way intended to limit the invention, its application, or uses. Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and to normal grammatical variations of the initially defined abbreviation; and, unless expressly stated to the contrary, measurement of a property is determined by the same technique as previously or later referenced for the same property.

As used herein, “over-molding” refers to the injection molding process in which a first material is molded onto a second material. When properly performed, the first material forms a strong bond with the second material without the use of primers or adhesives.

As used herein, “over-molded bond” refers to the bond between a first material and a second material when the first material is over-molded onto the second material. It should be appreciated that the precise nature of the over-molded bond will depend on the type of materials bonded together. For example, if two plastics are bonded together the over-molded bond is typically cohesive in nature. If a resin is bonded to a somewhat porous material like clothe, the resin tends to fill openings in the clothe to form a type of interlocking bond.

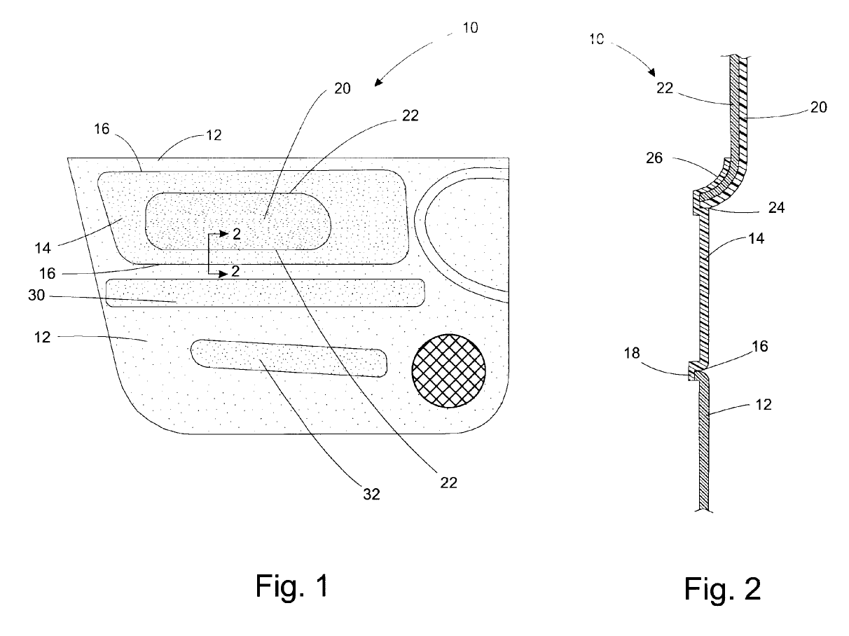

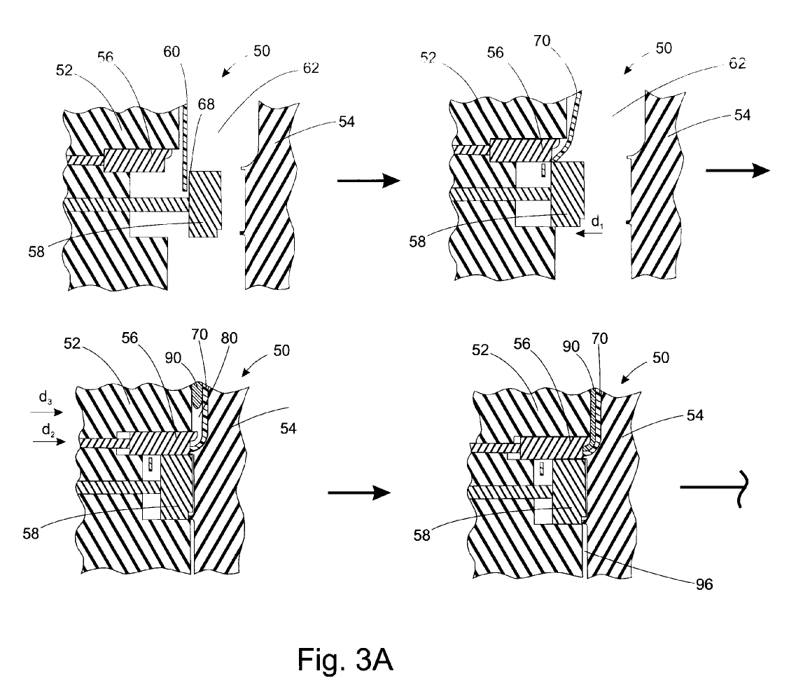

With reference to FIGS. 1 and 2, illustrations of an automobile interior panel made by the method of the invention are provided. FIG. 1 provides a side view of an interior panel while FIG. 2 provides a cross-sectional view. Although virtual any interior panel can be of the construction described in FIGS. 1 and 2, door panels with such constructions are found to be particularly useful. Automobile interior panel 10 includes main panel 12 which includes additional structures attached thereto. Typically, main panel 12 comprises a plastic resin. Bolster 14 is attached to main panel 12 with an over-molded bond as defined above. Such attachment is in the vicinity of edge 16 which borders main panel 12. Moreover, attachment may be accompanied by bolster 14 overlaying at least a portion of main panel 12 at region 18. Bolster 14 also typically comprises a plastic resin which may have a different color or surface texture than main panel 12. Automobile interior panel 10 also includes applique 20 which overlays substrate 22. Substrate 22 is attached to bolster 14 with an over-molded bond. Such attachment is in the vicinity of edge 24 which borders bolster 14. Moreover, attachment may be accompanied by the applique 20 and substrate 22 combination overlaying at least a portion of bolster 14 at region 26. In a variation of this embodiment, substrate 22 and main panel 12 are continuous (i.e., a single part). Automobile interior panel 10 may also include additional components such as armrest 30 and map pocket 32.

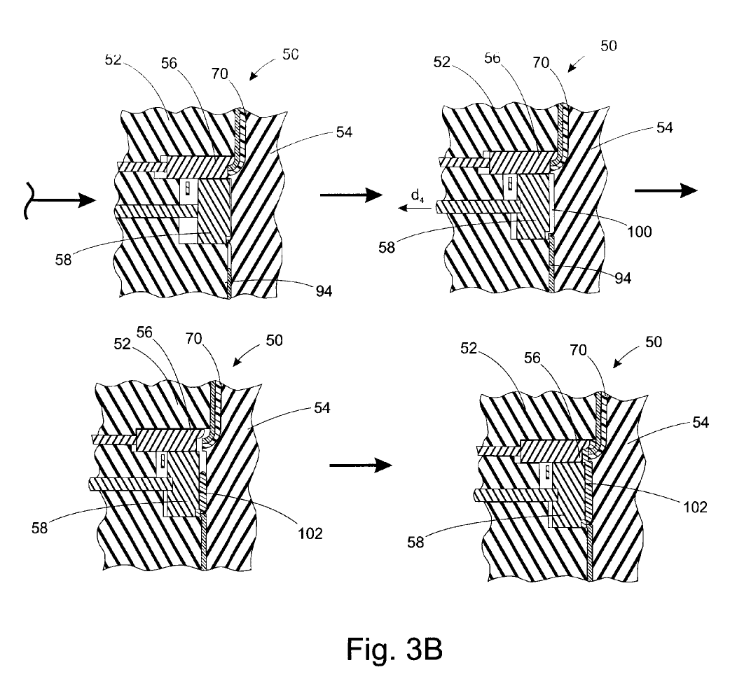

With reference to FIGS. 1, 2, 3A, and 3B, a schematic flowchart illustrating a method of forming an automobile interior panel is provided. The method of this embodiment is an injection molding process and in particular a low pressure injection molding process. The method of this embodiment is performed with molding system 50 which includes first mold section 52, second mold section 54, and first lifter 56. In a variation of this embodiment, molding system 50 includes additional lifters such as lifter 58. The method of the invention is particularly useful in low pressure molding. In accordance with the method of the invention, first insert 60 is positioned in first mold cavity 62. Moreover, at least a portion of first lifter 56 is positioned behind first lifter 58. First mold cavity 62 is formed by the appropriate relative positioning of first mold section 52 and second mold section 54.

Advantageously, first insert 60 is trimmed first lifter 56 to form trimmed first insert 70, typically with back edge 68. This trimming of first insert 56 is accomplished by moving first lifter 56 along direction d₁. Moreover, it should be appreciated that this trimming will shape first insert 60 into the general shape defined by edge 16. Next, first mold section 52, second mold section 54, first lifter 56, and trimmed first insert 70 are positioned to form second mold cavity 80. Again, a press is usually used for positioning first mold section 52 and second mold section 54. During this positioning, first lifter 56 is then moved along direction d₂ to an intermediate position while first mold section is moved in a relative sense along direction d₃. Positioning of first mold section 52 and second mold section 54 is usually accomplished with a press. First resin 90 is then introduced into second mold cavity 80 such that this first resin bonds to first trimmed insert 70. Typically, first resin 90 is introduced at an elevated temperature such that first resin 90 is in a liquid state (i.e., first resin 90 is melted). In the finished part, first resin 90 corresponds to substrate 22. Upon cooling first resin 90 is bonded to trimmed first insert 70 with an over-molded bond as defined above. Typically, first resin 90 is injected into second mold cavity 80 at a temperature from about 350° F. to about 440° F. and a pressure from about 700 psi to about 2100 psi. It should be appreciated that these temperature and pressure ranges will vary depending on the materials used. After the press closes the mold, the first resin is pushed behind first insert 70 filling out second mold cavity 80.

With reference to FIGS. 1, 2, 3A and 3B, the method of a variation of this embodiment further comprises introducing second resin 94 at elevated temperature into third mold cavity 96. This introduction of second resin occurs after the mold has completely closed. In the finished part, second resin 94 corresponds to main panel 12. Typically, first resin 90 is injected into third mold cavity 96 at a temperature from about 350° F. to about 440° F. and a pressure from about 700 psi to about 2100 psi. Again, it should be appreciated that these temperature and pressure ranges will vary depending on the materials used. In this variation, the positioning of first mold section 52, second mold section 54, first lifter 56, and trimmed first insert 70 to form second mold cavity 80 is accompanied by the positioning of lifter 58 to form third mold cavity 96. After third mold cavity 96 is filled, second lifter 58 is retracted along direction d₄ to expose fourth mold cavity 100. Third resin 102 is introduced into fourth mold cavity 100 to form bolster 14. Sometimes, bolster 14 is referred to as a second insert. Again, third resin 102 is injected into fourth mold cavity 100 at a temperature from about 350° F. to about 440° F. and a pressure from about 700 psi to about 2100 psi. It should be appreciated that these temperature and pressure ranges will vary depending on the materials used.

In the finished product, first insert 60 corresponds to applique 20 described in FIGS. 1 and 2. In some variations, first insert 60 comprises a thermoplastic resin selected from the group consisting of thermoplastic resins, cloth, leather, and combinations thereof. Examples of useful thermoplastic resins include thermoplastic polyurethanes, thermoplastic olefins, polyvinyl chloride, polypropylene, and combinations thereof. More specific examples from which first insert may be formed are homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

First resin 90, second resin 94, and third resin 106 each independently comprise a thermoplastic resin. Examples of useful thermoplastic resins include thermoplastic polyurethanes, thermoplastic olefins, polyvinyl chloride, polypropylene, and combinations thereof. More specific examples from which first resin 90, second resin 94, and third resin 106 may be formed are homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of forming an automobile interior panel in a molding system comprising a first mold section, a second mold section, and a first lifter, the method comprising:
a) positioning a first insert within a first mold cavity formed by the first mold section and the second mold section;
b) trimming the first insert with the first lifter to form a trimmed first insert;
c) positioning the first mold section, the second mold section, the first lifter, and the trimmed first insert to form a second mold cavity; and
d) introducing a first resin into the second mold cavity that contacts and bonds to the first trimmed insert.

2. The method of claim 1 wherein the first insert comprises a component selected from the group consisting of thermoplastic resins, cloth, leather, and combinations thereof.

3. The method of claim 2 wherein the first insert comprises a thermoplastic resin selected from the group consisting of thermoplastic polyurethanes, thermoplastic olefins, polyvinyl chloride, polypropylene, and combinations thereof.

4. The method of claim 2 wherein the first insert comprises a thermoplastic resin selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

5. The method of claim 1 further comprising introducing a second resin into a third mold cavity that forms the interior panel's main panel; wherein the low pressure mold further comprises a mold such that the positioning in step c) includes positioning of the second lifter to form the third mold cavity.

6. The method of claim 5 further comprises:
e) retracting the first lifter to expose a fourth mold cavity; and
f) introducing a third resin into the fourth mold cavity to form a second insert.

7. The method of claim 6 wherein the first resin, the second resin and the third resin each independently comprise a thermoplastic resin.

8. The method of claim 7 wherein the first resin, the second resin and the third resin each independently comprise a thermoplastic resin selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

9. An automobile interior panel made by the method of claim 1.

10. An automobile door panel made by the method of claim 1.

11. A method of forming an automobile interior panel in a low pressure mold comprising a first mold section, a second mold section, a first lifter, and a second lifter, the method comprising:
positioning a first insert within a first mold cavity formed by the first mold section and the second mold section;
trimming the first insert with the first lifter to form a trimmed first insert;
positioning the first mold section, the second mold section, the first lifter, the second lifter, and the trimmed first insert to form a second mold cavity and a third mold cavity;
introducing a first resin into the second mold cavity and the third mold cavity, the first resin contacting the first trimmed insert;
introducing a second resin into the third mold cavity that forms the interior panel's main panel;
retracting the first lifter to expose a fourth mold cavity; and
introducing a third resin into the fourth mold cavity to form a second insert.

12. The method of claim 11 wherein the first insert comprises a component selected from the group consisting of thermoplastic resins, cloth, leather, and combinations thereof.

13. The method of claim 11 wherein the first insert comprises a thermoplastic resin selected from the group consisting of thermoplastic polyurethanes, thermoplastic olefins, polyvinyl chloride, polypropylene, and combinations thereof.

14. The method of claim 11 wherein the first insert comprises a thermoplastic resin selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

15. The method of claim 11 wherein the first resin, the second resin and the third resin each independently comprise a thermoplastic resin.

16. The method of claim 15 wherein the first resin, the second resin and the third resin each independently a thermoplastic resin selected from the group consisting of homopolymers and copolymers of polyethylene, homopolymers and copolymers of polypropylene, thermoplastic olefins, thermoplastic urethanes, polycarbonate, acrylonitrile butadiene styrene, mixed acrylonitrile butadiene styrene and polycarbonate, and combinations thereof.

17. An automobile interior panel made by the method of claim 11.

18. An automobile door panel made by the method of claim 11.

19. A method of forming an automobile interior panel in a low pressure mold comprising a first mold section, a second mold section, a first lifter, and a second lifter, the method comprising:
positioning a first insert within a first mold cavity formed by the first mold section and the second mold section;
trimming the first insert with the first lifter to form a trimmed first insert;
positioning the first mold section, the second mold section, the first lifter, the second lifter, and the trimmed first insert to form a second mold cavity and a third mold cavity;
introducing a first resin into the second mold cavity that contacts and bonds to the first trimmed insert;
introducing a second resin into the third mold cavity that forms the interior panel's main panel;
retracting the first lifter to expose a fourth mold cavity; and
introducing a third resin into the fourth mold cavity to form a second insert.

20. An automobile interior panel made by the method of claim 19.
